(19) United States
(12) Patent Application Publication
(10) Pub. No.: US 2013/0220485 A1
(43) Pub. Date: Aug. 29, 2013

(54) CUTTING TOOL

(71) Applicants: Svante Larsson, Umea (SE); Peter Boman, Savar (SE)

(72) Inventors: Svante Larsson, Umea (SE); Peter Boman, Savar (SE)

(21) Appl. No.: 13/776,815

(22) Filed: Feb. 26, 2013

Related U.S. Application Data
(60) Provisional application No. 61/605,138, filed on Feb. 29, 2012.

(51) Int. Cl. B27G 13/12

(52) U.S. Cl. CPC B27G 13/12
USPC 144/134.1

(57) ABSTRACT

The cutting tool has a shaft and spherical cutting head having a groove defined therein extending from a top portion to a bottom portion of the cutting head. A disc-shaped first blade is placed in the groove. The first cutting blade has a peripheral cutting edge following a peripheral surface of the spherical cutting head. The peripheral cutting edge extends beyond the peripheral surface of the cutting head. The cutting tool is rotatable and in operation may be used to cut into a wood piece and create a crate-like cavity.

### PRIOR APPLICATION

This US patent application claims priority from U.S. patent application Ser. No. 61/605,138, filed 29 Feb. 2012.

### TECHNICAL FIELD

The invention relates to a cutting tool for making cavities in wood pieces.

### BACKGROUND AND SUMMARY OF THE INVENTION

Conventional woodturning lathes and woodturning gouges have traditionally been used to turn cavities in wood pieces. Lathes are effective for certain applications because they can provide smooth surfaces. One major drawback is that grinders require skilled machinists and the shapes are limited to symmetrical cavities. Various hand-tools have been used for creating non-symmetrical cavities. Such hand-tools are not very precise and difficult to guide. They can also be dangerous to use when making non-symmetrical cavities. There is a need for a more effective tool for making cavities particularly non-symmetrical cavities.

The cutting tool of the present invention provides a solution to the above-outlined problems. More particularly, the cutting tool has a shaft and spherical cutting head. The cutting head has one or many grooves defined therein extending from a top portion to a bottom portion of the cutting head. Preferably, first and second disc-shaped blades are placed in the groove. The cutting blades have a peripheral cutting edge following a peripheral surface of the spherical cutting head. The peripheral cutting edge extends beyond the peripheral surface of the cutting head. The cutting tool is rotatable and in operation may be used to cut into a wood piece and create a crate-like cavity.

### BRIEF DESCRIPTION OF DRAWINGS

FIG. 1 is a perspective view of the cutting tool of the present invention;

FIG. 2 is a front view of the cutting tool of the present invention;

FIG. 3 is a detailed view of the cutting tool of the present invention;

FIG. 4 is a perspective view of the cutting tool of the present invention together with a work piece;

FIG. 5 is a front view of the cutting tool of the present invention together with a cross-sectional view of the work piece;

FIG. 6A is a perspective bottom view of a first alternative embodiment of the cutting tool of the present invention;

FIG. 6B is a detailed cross-sectional view of a bottom of the first alternative embodiment of the cutting tool of the present invention shown in FIG. 6A; and

FIG. 7 is a cross-sectional perspective view of a second alternative embodiment of the cutting tool of the present invention.

### DETAILED DESCRIPTION

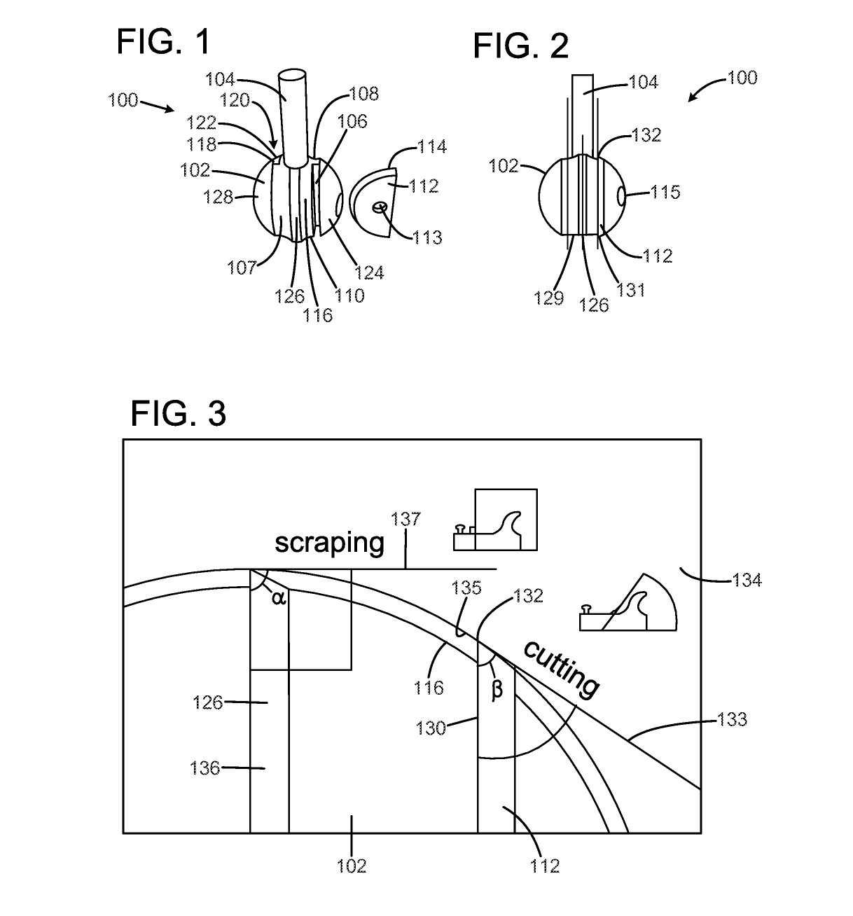

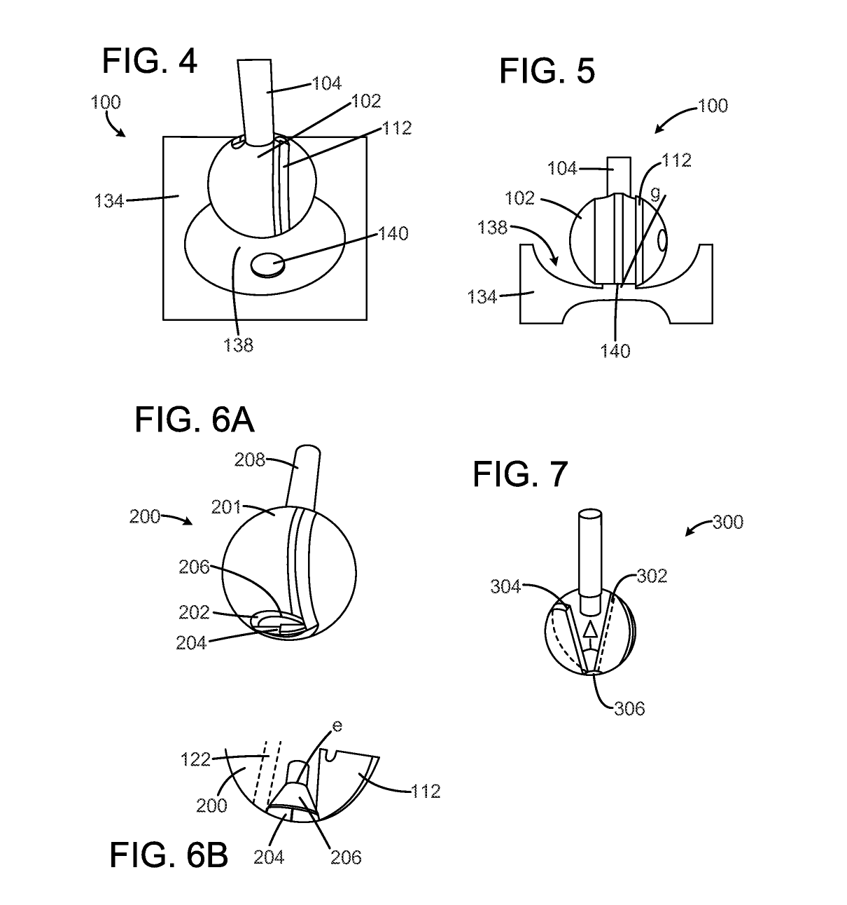

With reference to FIGS. 1-5, the present invention is a cutting tool 100 that has a spherical cutting head 102 and a shaft 104 attached thereto or integral therewith. Preferably, the shaft 104 is insertable into an electrical rotatable tool (not shown) such as a drilling machine and the like to rotate the cutting tool 100. The cutting head 102 is preferably made of a metal such as steel. It is also possible to use other materials that provide sufficient strength. The cutting head 102 has a first vertical groove 106 defined therein at a front side 107 that extends from a top portion 108 to a bottom portion 110 of the front side of the cutting head 102. A first cutting blade 112 is insertable into the groove 106. Preferably, the disc-shaped blade 112 may be a semicircle. The first cutting blade 112 has an opening 113 defined therein for receiving a fastener 115. The blade 112 may be held by the fastener 115 or the like that extends through the cutting head 102. The blade 112 may be held in the groove 106 in any suitable manner and is not limited to the use of a fastener such as a bolt. The blade 112 has a round outer peripheral cutting edge 114 that follows a curvature of a peripheral surface 116 of the cutting head 102. Preferably, the cutting head 102 has a second vertical groove 118 defined therein at a rear side 120 to hold a second cutting blade 122 that is identical or substantially identical to the first cutting blade 112. Preferably, the first cutting blade 112 is located on a right side 124 of a center line 126 facing forwardly while the second cutting blade 122 is located on a left side 128 facing rearwardly so that the first blade 112 faces away from the second blade 122. Preferably, the first cutting blade 112 and second cutting blade 122 are symmetrically placed on the cutting head 102. As best shown in FIG. 2, the cutting head 102 has a flat bottom surface 129 and the cutting blade has a bottom edge 131 that extends beyond the bottom surface 129 so that the bottom edge 131 of the cutting blade also can reach to cut the work piece 134.

As indicated above, the blade 112 has the cutting edge 114 that extends beyond the peripheral surface 116 of the cutting head 102. The blade 112 has a cutting end 132 that forms an acute cutting angle beta relative to a tangent 133 of a round cavity-shaped cutting-surface 135 of the work piece 134 for cutting into the work piece 134. Only the first cutting blade 112 is described in detail but the same description applies to the second cutting blade 122 because the blades are virtually identical. Preferably, two or more blades are used but it is also possible to only use one blade. One important feature of the present invention is that the blade 112 is located away from the center line 126. This enables the cutting to take place at a more acute cutting angle. An acute cutting angle is preferable because it cuts the wood piece along the wood fibers rather than scraping it. Scraping provides a rough surface while cutting provides a smooth surface. For cutting purposes, the cutting blades should be located as far as possible from the center line 126 i.e. closer to the fastener 115 because it reduces the cutting angle. If the cutting blades are placed too far away from the center line 126 there may not be sufficient supporting material in the cutting head 102. Also, placing the cutting blades wide apart creates a relatively large protrusion. The protrusion is explained in more detail below. For illustrative purposes, FIG. 3 includes a virtual blade 136 along the center line 126 to illustrate the point that the blade has a tendency to scrape the wood piece 134 instead of cutting when the cutting angle alpha between the virtual blade 136 and the tangent 137 of the work piece 134 is about 90 degrees. In contrast, the cutting angle beta between the blade 112 and the tangent 133 of the cutting surface 135 of the work piece 134 is less than 90 . More preferably, the cutting angle beta should be between 30 degrees and 45 degrees. Most preferably, the cutting angle beta should be between 32 degrees and 38 degrees. Therefore, the preferred embodiment does not have a blade located at the center line 126 but the location of the blades 112, 122 should be shifted away from the center line 126, as shown in FIGS. 1-2.

In operation, the cutting tool 100 is rotated and the cutting blades 112, 122 create a crater-like cavity 138 in the work piece 134. One important advantage of the present invention is that the cutting tool 100 may be used to create non-symmetrical cavities so that the cavity created may have any desirable shape. At the bottom of the cavity 138 a flat round protrusion 140 is formed when the cutting tool is used. This is the result of the bottom edge 131 of the blade 112 and the equivalent bottom edge of the blade 122 are not being able to reach and cut the area of the work piece 134 located between the blades 112 and 122. The height of the protrusion 140 is about the same as the distance the blades 112 and 122 extend beyond the flat bottom surface 129. The width of the protrusion 140 is decided by the distance between the blades and the center line 126. An important feature of the present invention is that the protrusion 140 may be used to hold the cutting tool in place and guide the cutting head 102 in place during operation in the work piece 134 while cutting the surface of the cavity 138. The protrusion 140 may easily be removed by gentle leaning the cutting tool 100 to one side so that one of the blades 112, 122 can reach the protrusion 140 and cut it away. However, this creates a new second protrusion located away from the protrusion 140. The operator may thus gradually move the guiding protrusion back and forth as the cutting head cuts and enlarges the cavity 138 of the wood piece 134.

FIG. 6A shows a perspective bottom view of a first alternative embodiment of the cutting tool 200. Everything is identical to the cutting tool 100 except that a cutting head 201 a bottom surface 202 having a round blade 204 or drill attached thereto to remove the protrusion that is formed, as described above. The tool 200 may have a cavity 206 (best seen in FIG. 6B) defined therein on a side that is, preferably, opposite a shaft 208 to accommodate the round blade 204. Preferably, the round blade 204 extends beyond the bottom surface 202 so that the blade 204 in combination with blades 112 and 122 form a round continuous cutting surface which means no protrusion is created when the cutting tool 200 is used. Preferably, the cutting blade 206 is aligned with the first cutting blade 112 and the second cutting blade 122. The second cutting blade 122 is shown with dashed lines in FIG. 6B since it is located behind the cutting tool 200 and not visible from the front.

FIG. 7 shows a second preferred embodiment of the cutting tool 300 that is identical to the cutting tool 100 except that the cutting blades 302 and 304 are positioned at an angle delta relative to one another so that the cutting blades meet at a bottom surface 306 of the cutting tool 300.

In other words, the cutting blade 302 is not parallel to the cutting blade 304. In this way, no protrusion or a very small protrusion is formed when the cutting tool 300 is used.

The cutting tool of the present invention provides several unexpected advantages. It may efficiently be used to cut spherical cavities and the protrusion may be used to hold and guide the tool during the operation which makes the tool very stable and precise while the rotating blades are applies against the surface of the wood piece.

While the present invention has been described in accordance with preferred compositions and embodiments, it is to be understood that certain substitutions and alterations may be made thereto without departing from the spirit and scope of the following claims.

1. A cutting tool for cutting a wood piece, comprising,
a shaft and spherical cutting head having a groove defined therein extending from a top portion to a bottom portion of the cutting head,
a disc-shaped first blade placed in the groove, the first cutting blade having a peripheral cutting edge following a peripheral surface of the spherical cutting head,
the peripheral cutting edge extending beyond the peripheral surface of the cutting head,
rotating means for rotating the shaft and the cutting head, and
the first cutting blade having cutting means for cutting into a wood piece and creating a crate-like cavity.

2. The method of claim 1 wherein the method further comprises the cutting head having a flat bottom surface and a cutting edge of the cutting blade that extends beyond the bottom surface, the cutting edge having protrusion means for creating a round protrusion in the cavity.

3. The cutting tool of claim 1 wherein the method further comprises the cutting head having a second groove defined therein at a rear side of the cutting head, the second groove having a second cutting blade inserted therein.

4. The cutting tool of claim 1 wherein the first cutting blade is located remotely and shifted away from a center line of the cutting head.

5. The cutting tool of claim 1 wherein the first cutting blade is parallel to a plane of the center line.

6. The cutting tool of claim 1 wherein a cutting end of the first cutting blade form an acute angle beta relative to a tangent of a cutting surface of the work piece.

7. The cutting tool of claim 3 wherein the first cutting blade is located at a front side while the second cutting blade is located at a rear side so that the first cutting blade faces away from the second cutting blade.

8. The cutting tool of claim 1 wherein the first cutting blade has an opening defined therein for receiving a fastener.

9. The cutting tool of claim 1 wherein a bottom surface of a cutting head has a cavity defined therein for receiving a round blade.

10. The cutting tool of claim 1 wherein the round blade extends beyond the bottom surface and is aligned with the first cutting blade and the second cutting blade.
